(19) United States
(12) Patent Application Publication
(10) Pub. No.: US 2019/0013000 A1
(43) Pub. Date: Jan. 10, 2019

(54) STRINGED-INSTRUMENT PICKUP WITH MAGNET FRAGMENTS

(71) Applicant: 3rd Power Amplification LLC, Nashville, TN (US)

(72) Inventor: Jamie Scott, Nashville, TN (US)

(73) Assignee: 3rd Power Amplification LLC, Nashville, TN (US)

(21) Appl. No.: 16/031,933

(22) Filed: Jul. 10, 2018

Related U.S. Application Data
(60) Provisional application No. 62/530,752, filed on Jul. 10, 2017.

(51) Int. Cl. G10H 3/18

(52) U.S. Cl. CPC G10H 3/181; G10H 2220/461; G10H 3/182

(57) ABSTRACT

The present disclosure provides for a magnetic pickup configured for use in a stringed instrument, for example, an electric guitar. The magnetic pickup creates a signal indicative of the vibration in a number of metallic strings. When the strings are strummed or otherwise agitated, the resonating strings modify the magnetic field, which is captured in an electric signal that is sent to an amplifier for reproduction of the sound resonating from the strings. The magnetic pickup has a number of different strength magnetic fragments such that different strings are proximate to the different magnetic fragments. The different strengths of the magnetic fragments result in a static magnetic field that is different for the different strings.

This application claims the benefit of and is a non-provisional of co-pending U.S. Provisional Application Ser. No. 62/530,752 filed on Jul. 10, 2017, which is hereby expressly incorporated by reference in its entirety for all purposes.

This disclosure relates in general to stringed-instrument pickups and, but not by way of limitation, to magnet configurations in pickups.

### BACKGROUND

This disclosure relates in general to electric stringed instruments and, but not by way of limitation, to improved pickups with novel magnetic properties.

A permanent magnet is used in electric pickups to capture string vibration. Different pickups use different magnets. Since the advent of the electric guitar, innovators have tried to more accurately capture the guitar sound with electronics.

A given stringed instrument will typically have a number of strings that resonate at different frequencies to produce sound. Despite having different frequencies, the capture of that vibration is done the same. Certain pickups are better at capture of some strings, but not others. Conventional pickup design is a compromise.

### SUMMARY

In one embodiment, the present disclosure provides for a magnetic pickup configured for use in a stringed instrument, for example, an electric guitar. The magnetic pickup creates a signal indicative of the vibration in a number of metallic strings. When the strings are strummed, the resonating strings modify the magnetic field, which is captured in an electric signal that is sent to an amplifier for reproduction of the sound resonating with the strings. The magnetic pickup has a number of different strength magnetic fragments such that different strings are proximate to the different magnetic fragments. The different strengths of the magnetic fragments result in a static magnetic field that is different for the different strings.

In another embodiment a pickup for stringed instrument is disclosed. The pickup includes first and second magnetic fragments. The second magnetic fragment aligned with the first magnetic fragment in such a way as both are perpendicular to strings during normal operation. The pole pieces, includes first and second subsets. The first subset of pole pieces are coupled to the first magnetic fragment, and the second subset of pole pieces are coupled to the second magnetic fragment.

In yet another embodiment, a pickup for a stringed instrument is disclosed that includes first and second magnetic fragments. The second magnetic fragment is aligned with the first magnetic fragment. The magnetic strength of the first magnetic fragment is different from the second magnetic fragment.

In still another embodiment, a pickup for a stringed instrument is disclosed having a plurality of magnetic fragments with a plurality of different magnetic strengths. The pickup has a plurality of pole pieces magnetically engaged with the plurality of magnetic fragments.

In various embodiments, different options are possible. The alignment of the plurality of magnetic fragments may be perpendicular to strings during normal operation. A first subset of the pole pieces are coupled to the first magnetic fragment, and a second subset of the plurality of pole pieces may be coupled to the second magnetic fragment. The plurality of magnetic fragments may have a plurality of different alloys. The plurality of magnetic fragments comprise two, three, four, five or six magnetic fragments. The magnetic fragments may rectangular, parallelogram, circular, triangular or other geometric shapes. The plurality of magnetic fragments may have a plurality of different shapes and/or dimensions.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures:

FIG. 1 depicts a magnetic fragment with magnetic flux lines between north and south poles of the magnetic fragment;

FIG. 2 depicts a side view of a pickup portion shown in cross-section interacting with a metallic string;

FIG. 3 depicts a side perspective view of a pickup portion showing a complete magnetic fragment for two strings;

FIG. 4 is a table showing different magnet alloys;

FIG. 5 depicts a top plan view of portions of a pickup that use three different magnetic fragments;

FIG. 6 depicts a side-perspective view of portions of a pickup of the embodiment in FIG. 5;

FIG. 7 shows a side-perspective view of the portions of the pickup for the embodiment of FIG. 5 engaged with the six different strings of an electric guitar;

FIG. 8 depicts a top plan view of the pickup with the bobbins shown in dashed lines;

FIG. 9 depicts an exploded view of the pickup in perspective view;

FIG. 10 depicts four different magnetic fragment configurations with dimensioning;

FIG. 11 depicts different configurations of the magnetic fragments with respect to the strings;

FIGS. 12-18 depict different configurations of the magnetic fragments with flux lines;

FIG. 19 depicts portions of a pickup with a single string shown overlaid for simplicity; and

FIG. 20 shows a side-sectional view of the pickup from FIG. 19.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims

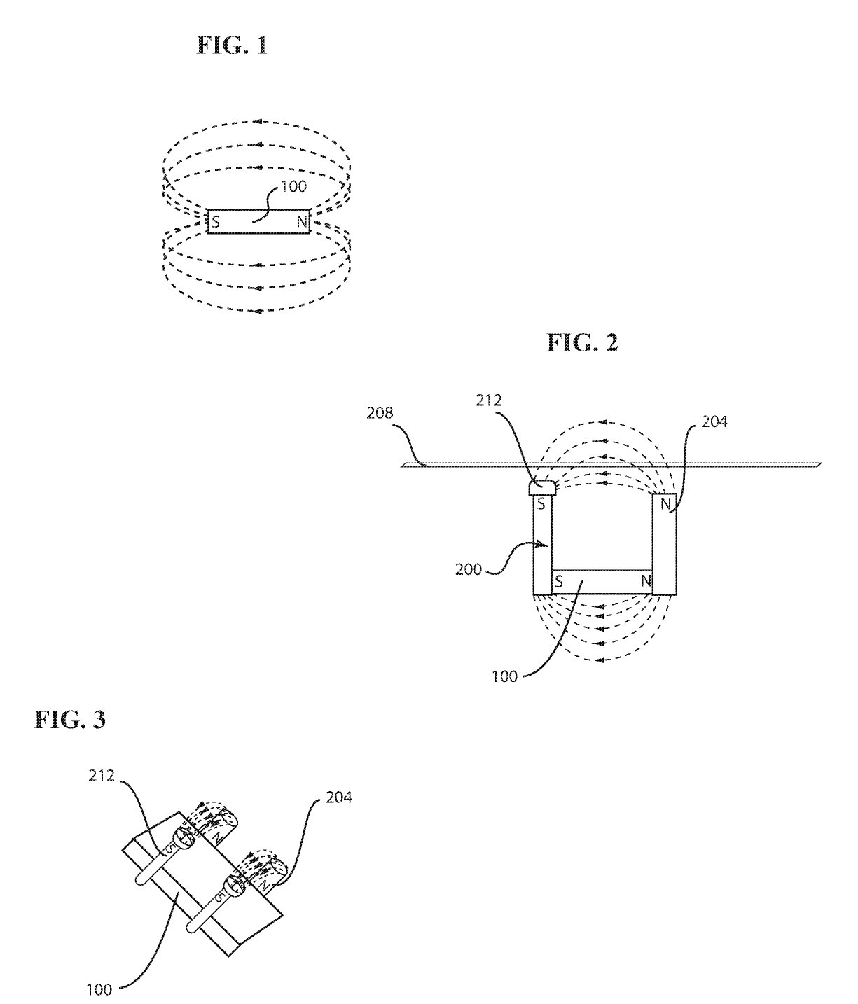

Referring initially to FIG. 1, an embodiment of a magnetic fragment 100 is shown with magnetic flux lines between north and south poles of the magnetic fragment 100. The magnetic fragment 100 is a permanent magnet and has varying strengths and dimensions in the various configurations.

With reference to FIG. 2, an embodiment of a side view of a pickup portion 200 shown in cross-section is shown interacting with a metallic string 208. The magnetic fragment 100 is coupled to a pole piece screw 212 and a slug 204. The pole piece screw 212 is adjustable by rotation such that it can be closer or further from the metallic string 208. Magnetic flux lines are shown traversing the magnetic string 208. In this embodiment, the pole piece screw 212 and slug 204 pass the magnetic field of the magnetic fragment 100, but the pole piece screw 212 and slug 204 are not otherwise magnetized.

Referring next to FIG. 3, an embodiment of a side perspective view of a pickup portion 300 showing a magnetic fragment 100 configured to engaged with two strings 208 (not shown) with two sets of pole piece screws 212 and slugs 204. In this embodiment, the magnetic fragment 100 is coupled to two strings 208 during normal operation. The size and shape of the magnetic fragment 100 along with its magnetic strength has different sound properties, note sensitivity and dynamic properties.

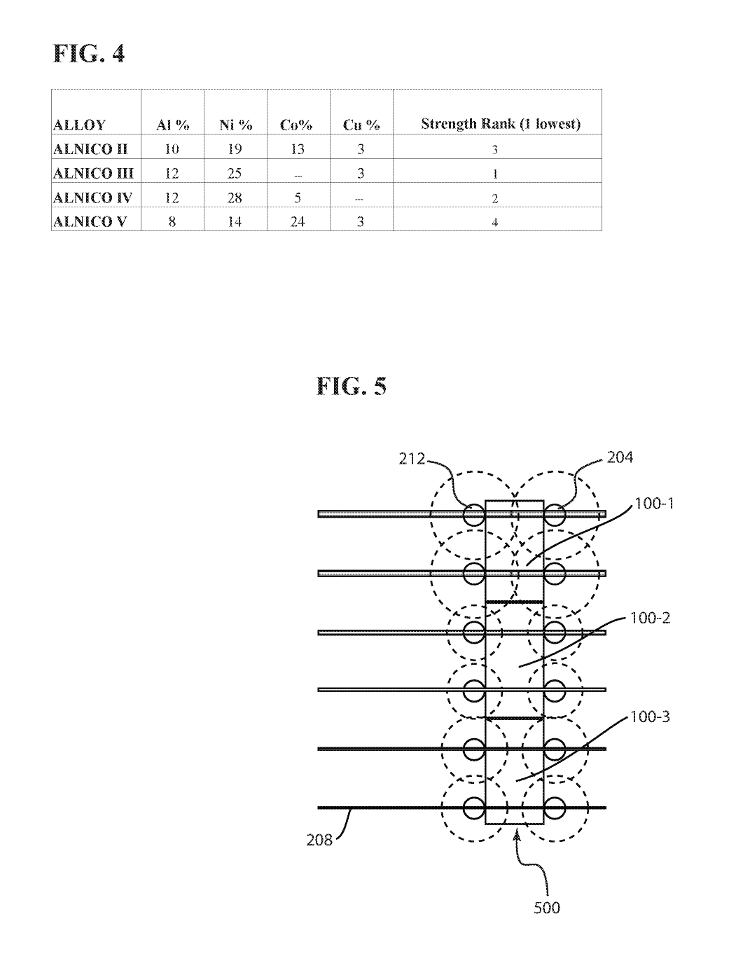

With reference to FIG. 4, an embodiment of a table showing different magnet types is shown. The different alloys popular for magnetic pickups is shown. Different embodiments are not limited to these alloys or properties. Mixing a variety of these magnet types as magnetic fragments 100 with respect to the strings provides a richer pickup dynamic in various embodiments.

Referring next to FIG. 5, an embodiment of a top view of a portions of a pickup 500 is shown that uses three different magnetic fragments 100. A first magnetic fragment 100-1 is made of an Alinco V alloy and placed beneath the largest strings 208. A second magnetic fragment 100-2 is made of an Alinco IV alloy and placed beneath the two middle strings. A third magnetic fragment 100-3 is made of an Alinco II alloy and placed beneath the bottom two strings. The three magnetic fragments are press fit together even though shown with a small spacing between them. Different embodiments could have the magnet fragments 100 touching, or separated by up to 1.5 times the spacing between strings although 1-5 mm is more typical.

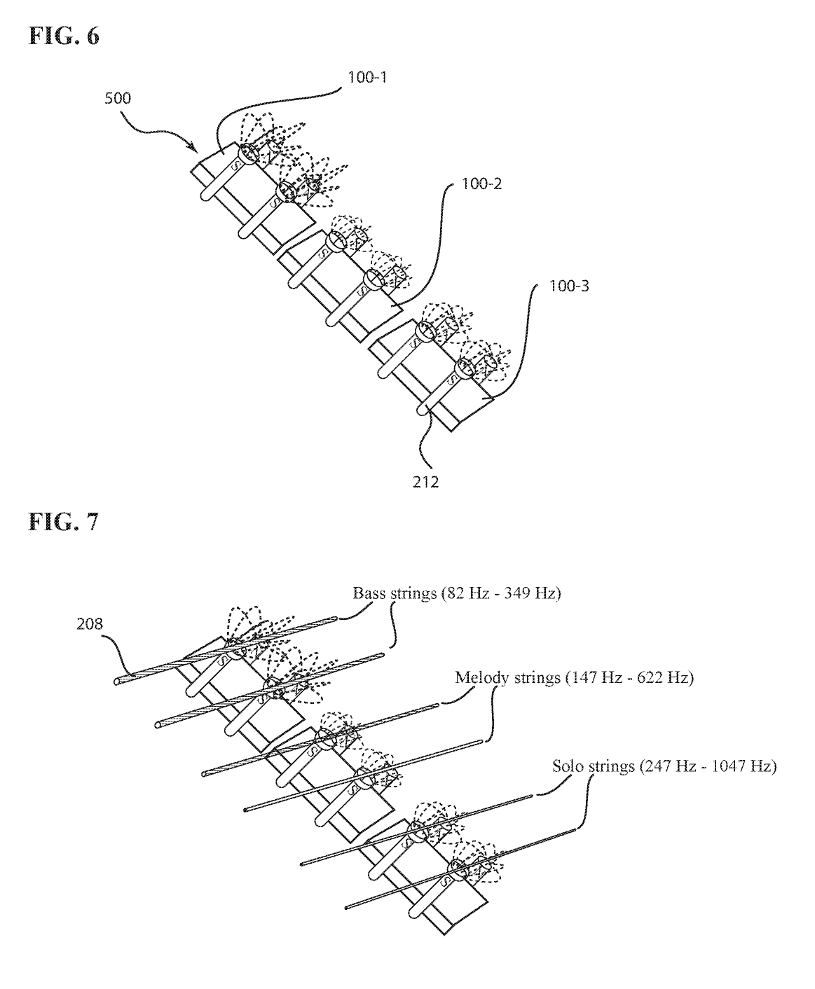

With reference to FIG. 6, a side-perspective view of portions of a pickup 500 is shown of the embodiment in FIG. 5. Magnetic flux lines are shown with dashed lines. The magnetic fragments 100 are shown with separation, but could be coupled together with a press fit, soldering, electrically conducted paste, or non-conductive glue or tape.

FIG. 7 shows the portions of the pickup 500 for the embodiment of FIG. 5 engaged with the six different strings 208 of an electric guitar. As the strings resonate at their different tune frequencies, the magnetic field is disturbed to couple the vibrations to the amplifier (not shown).

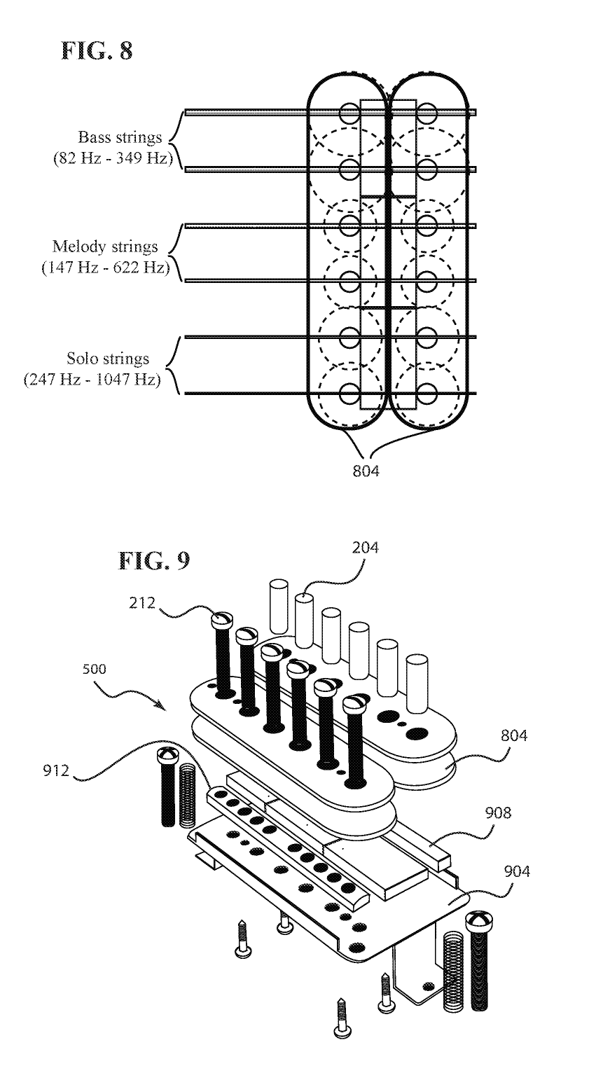

Referring next to FIG. 8, a top view of the pickup 500 is shown with the bobbins 804 depicted. Each of the bobbins 804 is wound with wire respectively wound around the pole pieces 212 or the slugs 204. The bobbin 804 is the plastic cylinder that the actual wire is wound onto forming the coil of wire. FIG. 8 and some of the other figures use a dashed circle around the pole pieces 212 and slugs 204 to denote the perceived string sensitivity due to the different magnetic strength of the different types of magnets used per each string pair in one embodiment.

Solo Strings are more piercing in sound—more bright. They don't have a lot of fullness to the sound quality. Therefore, we use a warm sounding magnet that delivers a warmer sound with a somewhat volatile flux response when disturbing the magnetic field (relative to the other magnet types used). This can be summarized as follows: bright tinny strings that are small in diameter and quick in their response to being plucked paired with a slower, weaker, warmer sounding magnet results in a sound that is balanced, sweet, smooth and very musical. Melody Strings have more output and a slightly warmer sound than the solo strings. Therefore a quicker, more responsive magnet is used. Bass Strings have a lot of low frequency content and less transient response. Therefore, a very fast, very hight output magnet is used that is also inherently bright sounding. In use, bright, fast magnet pairs up wonderfully with the slower, boomier bass strings.

With reference to FIG. 9, an exploded view of the pickup 500 is shown. The magnetic fragments 100 are mounted to a baseplate 904 and between a shim 908 and a metal spacer 912. The metal spacer 912 is threaded to engage the pole piece screws 212. The metal spacer 912 and shim 908 press fit against the magnetic fragments 100 and magnetically and electrically couple them with the slugs 204 and pole piece screws 212.

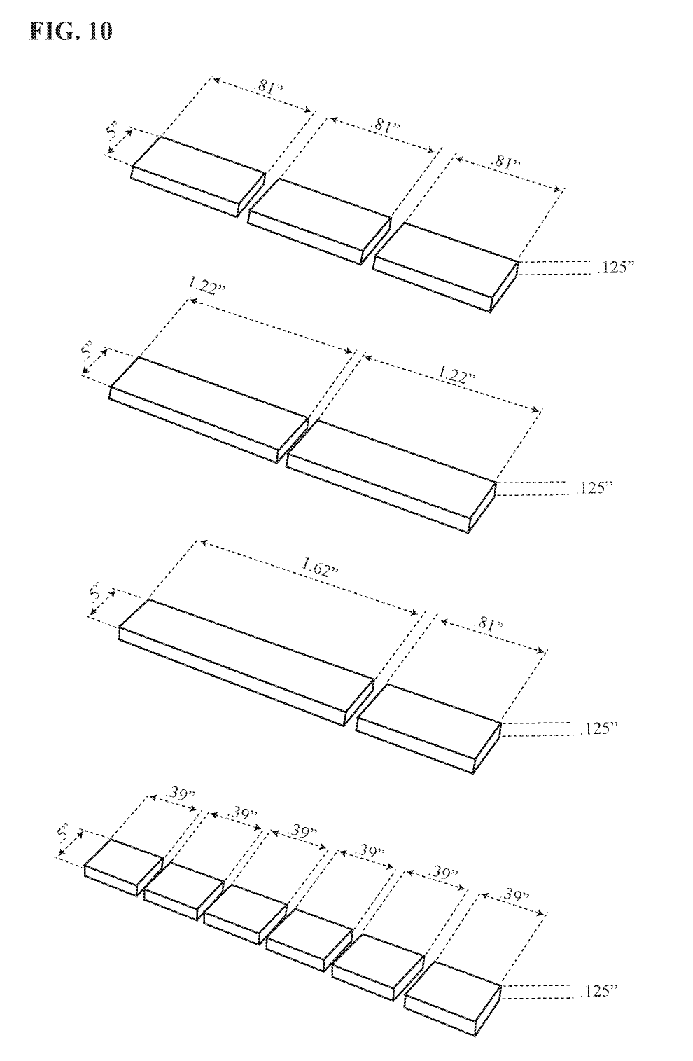

Referring next to FIG. 10, various embodiments of the magnetic fragment 100 configurations are shown. FIG. 10 shows four different configurations with the dimensioning, but any different sizing or configuration could be used in other embodiments. Each of the fragments is of a different alloy with different magnetic properties than its adjacent fragment. Different stringed instruments will dictate different dimensions for the magnetic fragments 100 so the pickup magnetic field engages the strings. For example, a harp, violin, bass guitar, sitar, etc. may each have different dimensioning.

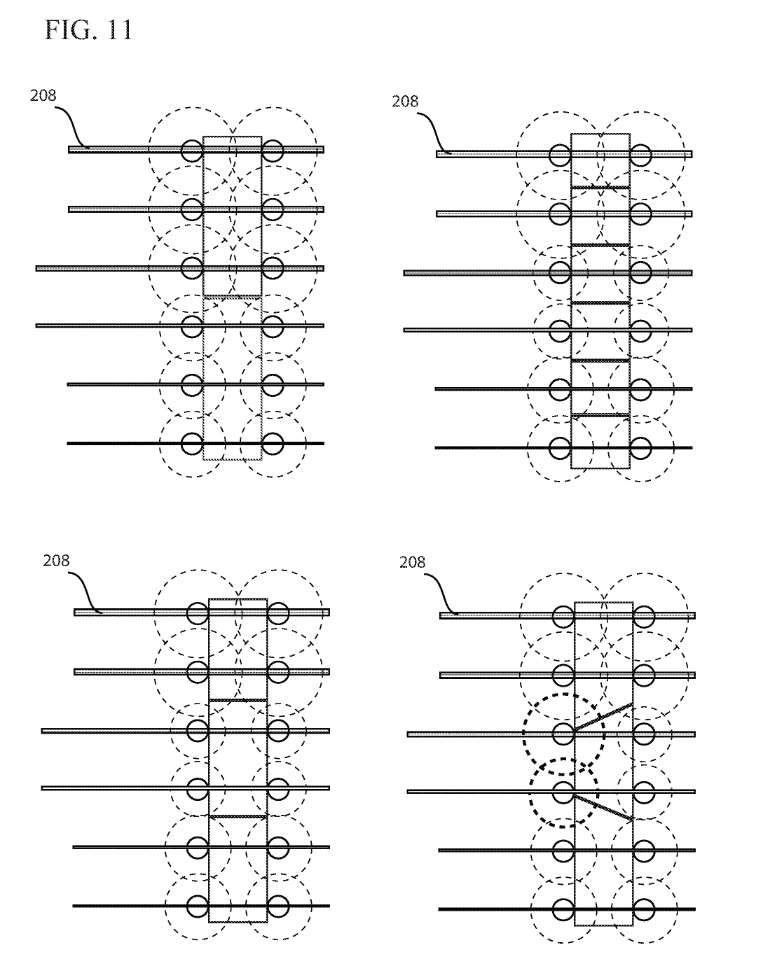

With reference to FIG. 11, other embodiments for configuring the magnetic fragments 100 with respect to the strings are shown. For example, two, six, or three different magnetic fragments 100 are shown in the four embodiments. Most are rectangular, but one embodiment of the pickup only has two sides of each magnetic fragment parallel to each other with at least one side at a diagonal.

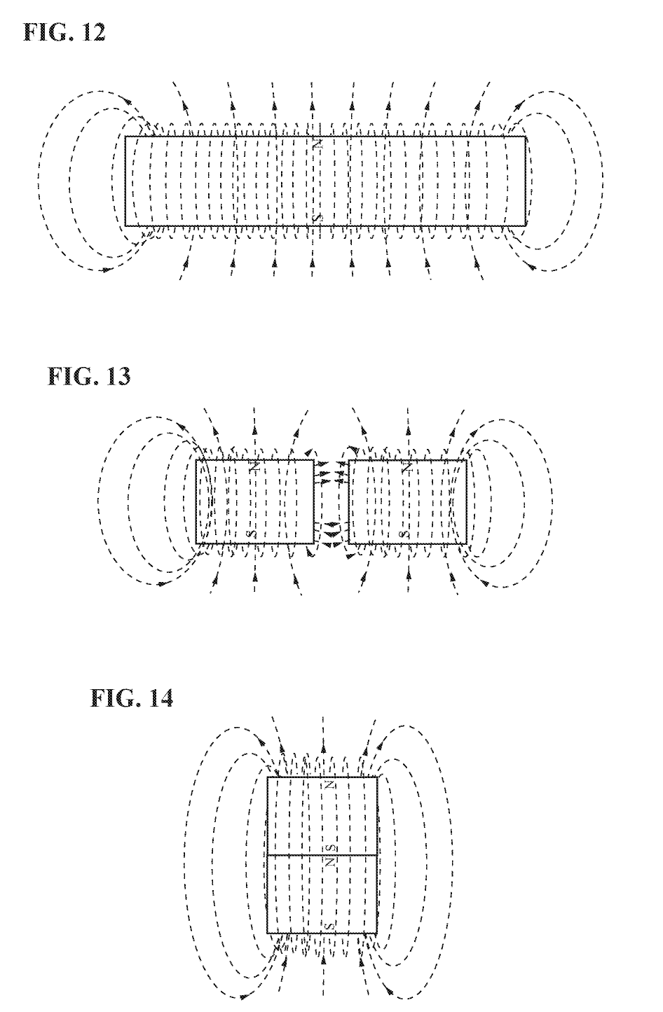

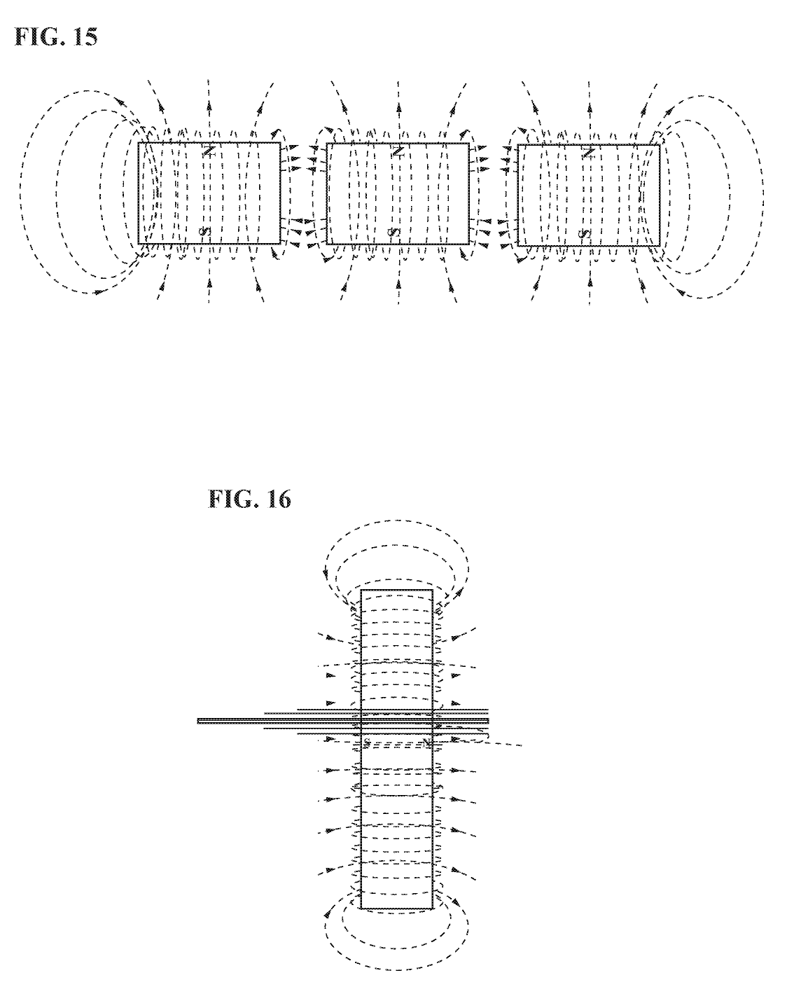

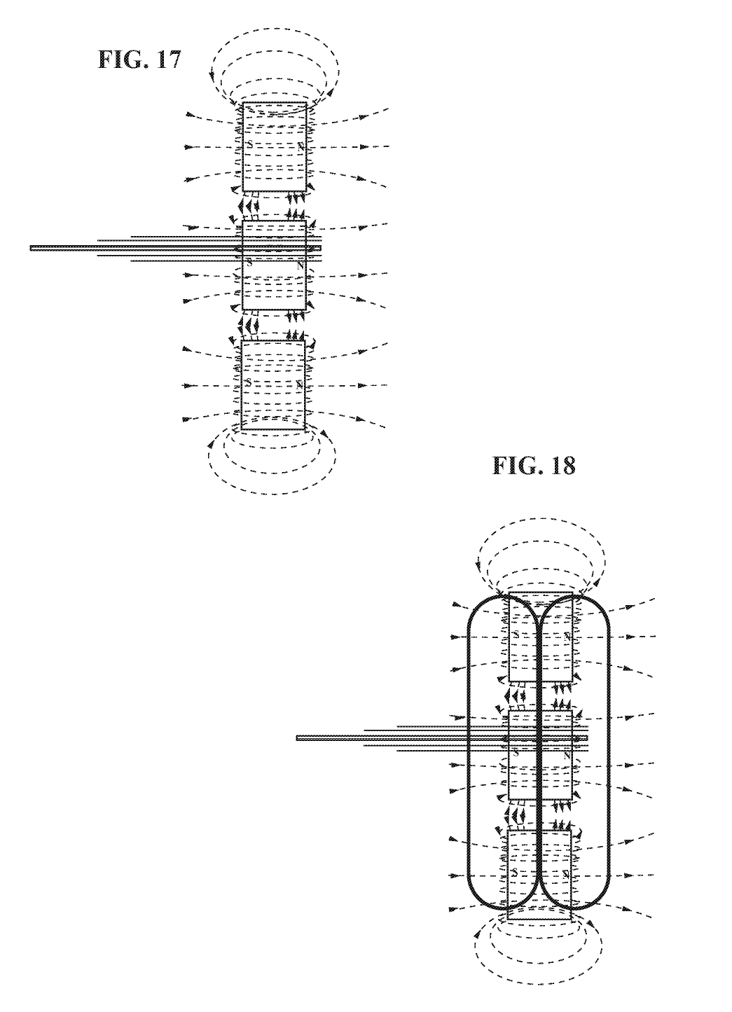

Referring to FIGS. 12-18, different configurations of the magnetic fragments are shown with flux lines shown as dashed arrows. Interaction between separated (e.g., FIG. 13, 15, 17, or 18) or abutted magnetic fragments 100 (e.g., FIG. 14) are shown.

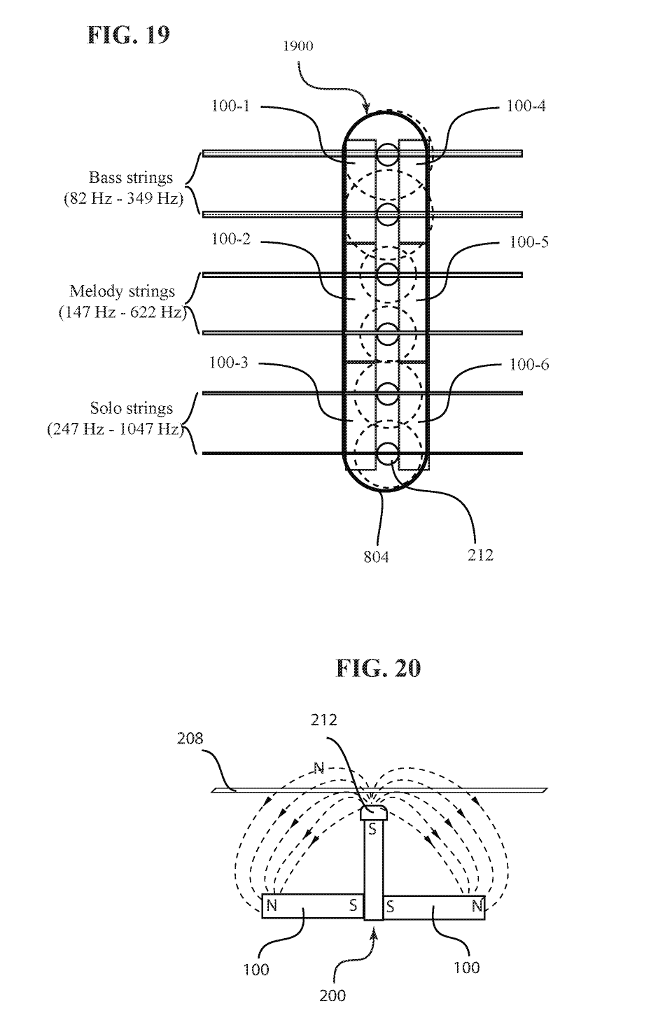

With reference to FIG. 19, another embodiment of a pickup 1900 is shown. This embodiment uses a single bobbin 804. Three magnetic fragments 100 are used on each side of the pole piece screws 212 for a total of six fragments 100. A disturbance in the magnetic field adjacent to the coil creates an electrical current in the coiled wire.

Referring next to FIG. 20, a side-sectional view of the pickup 1900 from FIG. 19 is shown. The magnet fragments 100 have the same polarity facing each other, separated by the pole piece in the case of a single coil with six pole piece screws 212 and six magnet fragments 100 configured with three magnetic fragments on each side of the line of pole piece screws 212.

A number of variations and modifications of the disclosed embodiments can also be used. For example, any number of fragments with any number of alloys could be used. The pickup could be used with any stringed instrument with any number of strings. There could be two or more pole piece screws and slugs for each string of the instrument. Although the magnetic fragments are shown perpendicular to the strings, other embodiments could have the magnetic fragments arranged at any angle with respect to the strings. Although the magnetic fragments shown are rectangular or parallelograms, different embodiments could have them in any geometric shape such as round, triangular, spherical, hexagram, pentagram, etc. The slugs and pole piece screws are shown adjacent to the magnetic fragments, but could pierce through the magnetic fragments in other embodiments.

In another embodiment, there is substantial sonic clarity and note definition even if all magnetic fragments used the same alloy and/or were of the same dimensions. One benefit being that the null created by collapsing field at the point at which each of the fragments join is one reason we have reduced the distortion and phase smearing of the signal as that is generated in the coil of wire. The wire coil is adjacent to the actual magnetic fragments. For the side of the pickup near the strings, pole pieces provide that the string vibrations are still being captured. The signal quality within the coil is improved by dramatically reducing the disturbance of the flux field in this embodiment.

While the principles of the disclosure have been described above in connection with specific apparatuses and methods, it is to be clearly understood that this description is made only by way of example and not as limitation on the scope of the disclosure.

What is claimed is:

1. A pickup for stringed instrument, the pickup comprising:
a first magnetic fragment;
a second magnetic fragment aligned with the first magnetic fragment, wherein alignment is perpendicular to strings during normal operation;
a plurality of pole pieces, wherein:
a first subset of the plurality of pole pieces are coupled to the first magnetic fragment, and
a second subset of the plurality of pole pieces are coupled to the second magnetic fragment.

2. The pickup for the stringed instrument of claim 1, further comprising a third magnetic fragment having a different alloy than at least one of the first and second magnetic fragments.

3. The pickup for the stringed instrument of claim 1, further comprising four magnetic fragments coupled to the first and second magnetic fragments.

4. The pickup for the stringed instrument of claim 1, wherein the magnetic strength of the first magnetic fragment is different from the second magnetic fragment.

5. The pickup for the stringed instrument of claim 1, wherein the first and second magnetic fragments are rectangular.

6. The pickup for the stringed instrument of claim 1, wherein the shape of the first magnetic fragment is different from the second magnetic fragment.

7. A pickup for a stringed instrument, comprising:
a first magnetic fragment;
a second magnetic fragment aligned with the first magnetic fragment, wherein the magnetic strength of the first magnetic fragment is different from the second magnetic fragment.

8. The pickup for the stringed instrument of claim 7, wherein alignment is perpendicular to strings during normal operation.

9. The pickup for the stringed instrument of claim 7, further comprising a plurality of pole pieces, wherein:
a first subset of the plurality of pole pieces are coupled to the first magnetic fragment, and
a second subset of the plurality of pole pieces are coupled to the second magnetic fragment.

10. The pickup for the stringed instrument of claim 7, further comprising a third magnetic fragment having a different alloy than at least one of the first and second magnetic fragments.

11. The pickup for the stringed instrument of claim 7, further comprising four magnetic fragments coupled to the first and second magnetic fragments.

12. The pickup for the stringed instrument of claim 7, wherein the first and second magnetic fragments are rectangular.

13. The pickup for the stringed instrument of claim 7, wherein the shape of the first magnetic fragment is different from the second magnetic fragment.

14. The pickup for a stringed instrument, comprising:
a plurality of magnetic fragments having a plurality of different magnetic strengths; and
a plurality of pole pieces magnetically coupled with the plurality of magnetic fragments.

15. The pickup for the stringed instrument of claim 14, wherein alignment of the plurality of magnetic fragments is perpendicular to strings during normal operation.

16. The pickup for the stringed instrument of claim 14, wherein:
the plurality of magnetic fragments include first and second magnetic fragments,
a first subset of the plurality of pole pieces are coupled to the first magnetic fragment, and
a second subset of the plurality of pole pieces are coupled to the second magnetic fragment.

17. The pickup for the stringed instrument of claim 14, wherein the plurality of magnetic fragments have a plurality of different alloys.

18. The pickup for the stringed instrument of claim 14, wherein the plurality of magnetic fragments comprise four magnetic fragments.

19. The pickup for the stringed instrument of claim 14, wherein at least one of the plurality of magnetic fragments is rectangular.

20. The pickup for the stringed instrument of claim 14, wherein the plurality of magnetic fragments have a plurality of different shapes.
